(19) United States
(12) Patent Application Publication
(10) Pub. No.: US 2021/0163685 A1
(43) Pub. Date: Jun. 3, 2021

(54) PHOTOSENSITIZER FOR A PHOTOCATHODE

(71) Applicant: CFSO GMBH, Geretsried (DE)

(72) Inventors: Oyewole TAYE SALAMI, Wolfratshausen (DE); Sigrid OBENLAND, Munich (DE); Christian FISCHER, Pohlheim (DE); Thorben SCHLUECKER, Ottobrunn (DE); Andreas WALTER, Antdorf (DE)

(21) Appl. No.: 16/772,873

(22) PCT Filed: Dec. 15, 2018
(86) PCT No.: PCT/EP2018/000562

§ 371 Date: Jun. 15, 2020

(30) Foreign Application Priority Data
Dec. 15, 2017 (DE) 10 2017 011 653.9

(51) Int. Cl. C08G 75/14; C07F 15/00; C25B 1/55; C25B 11/095; C08K 5/00; C25B 11/087; C25B 11/061

(52) U.S. Cl. CPC C08G 75/14; C07F 15/0046; C25B 1/55; C25B 11/061; C08K 5/0025; C25B 11/087; C25B 11/095

(57) ABSTRACT

An improved photosensitizer for a photocathode comprises an oligomeric or polymeric chromphore absorbing, as an ensemble, light at (a) wavelengths at or greater than 420 nm that includes at least 3 identical or different suitable monomeric chromophore units carrying at least two substituents each comprising at least one alkylene, alkenylene and/or alkynylene chain having a chain length of at least 3 carbon atoms, those substituents being terminated by thiol groups, wherein the oligomeric or polymeric chromphore has a disulfide bond between each of the chromophores. A photocathode comprising the photosensitzer is useful for the reduction of water-soluble chemicals in oxidized forms, including protons, with the aid of visible light in a system comprising the photocathode and a photoanode or any other anode or source of electrons. A method for reducing chemicals soluble in aqueous media in oxidized forms, including protons, in aqueous solutions by means of the photocathode is also disclosed.

### FIELD OF THE INVENTION

The invention relates to an improved photosensitizer comprising an oligomeric or polymeric chromphore, a photocathode comprising the photosensitizer which is inter alia useful for the reduction of protons and/or dissolved chemicals in oxidized form in an aqueous medium with the aid of visible light, a system comprising the photocathode and a photoanode or any other anode or source of electrons as well as a method for reducing protons and/or chemicals soluble in aqueous media in oxidized form in an aqueous medium by means of the system comprising the photocathode.

### BACKGROUND ART

WO 2009/056348 A1, incorporated herein in its entirety, discloses a catalyst system for the cleavage of water into hydrogen and oxygen with the aid of light and a method of producing hydrogen and oxygen using the catalyst system, and explains how the catalyst system functions. One of the materials used therein for the preparation of a photocathode (designated therein as second photoactive material) is tris[4-(11-mercaptoundecyl)-4′-methyl-2,2′-bipyridine]ruthenium(II)-bis-(hexafluorophosphate).

It has now been discovered that the yield of the reduction of hydrogen or a compound that can be reduced by hydrogen at the photocathode can be considerably improved, if the photosensitizer is an oligomer or polymer of the ruthenium complex or an oligomer or polymer of any other chromophore absorbing light at wavelenghts at or above 420 nm having at least two SH groups bound to it via chains comprising alkylene, alkenylene or alkynylene groups wherein the oligomer or polymer comprises at least 3 monomeric units. The oligomer or polymer includes disulfide moieties inserted in alkylene, alkenylene or alkynylene chains attached to the chromophore. Upon irradiation, an excited electronic state is produced, and photoconduction of electrons proceed alongside the chain structure which in turn is connected in an electronically conductive way to a carrier and a catalyst capable of reducing H+ ions and oxidized organic species that can be reduced with hydrogen in an aqueous medium, when provided with electrons.

### SUMMARY OF THE INVENTION

In a first aspect, this invention relates to a photosensitizer comprising an oligomeric or polymeric chromphore absorbing, as an ensemble, light at (a) wavelengths at or greater than 420 nm that includes at least 3 identical or different suitable monomeric chromophore units carrying at least two substituents each comprising at least one alkylene, alkenylene and/or alkynylene chain having a chain length of at least 3 carbon atoms, those substituents being terminated by thiol groups, wherein the oligomeric or polymeric chromphore has a disulfide bond between each of the chromophores prepared by means of combining two thiol groups of two individual monomeric units by oligomerization or poylmerization of the monomeric units to form the oligomeric or polymeric chromphore.

Furthermore, this invention relates to a photocathode comprising the photosensitizer, and a device for reducing protons in the aqueous medium and/or a chemical compound dissolved in the aqueous medium that can be reduced by hydrogen comprising the photocathode and an electron source being in electrically conductive connection with the photocathode.

Finally, the invention relates to a method of reducing in an aqueous medium protons or a chemical compound that can be reduced by hydrogen, wherein the cathode of the device is. immersed in an aqueous medium containing protons or protons and the chemical compound, respectively, at a temperature above room temperature, the photocathode being connected to an electron source in an electronically conductive fashion, and is irradiated with light comprising wavelengths in the visible region at or above 420 nm, and wherein further the hydrogen produced at the photocathode is collected, or wherein the chemical compound reduced at the photocathode is collected within the aqueous medium or alternatively by separating it from the aqueous medium, respectively.

### BRIEF DESCRIPTION OF THE DRAWINGS

FIG. 1 shows a schematic representation of poly{tris[4-(11-mercaptoundecyl)-4′-methyl-2,2′-bipyridine]ruthenium(II)-bis-(hexafluorophosphate)} attached to a gold surface.

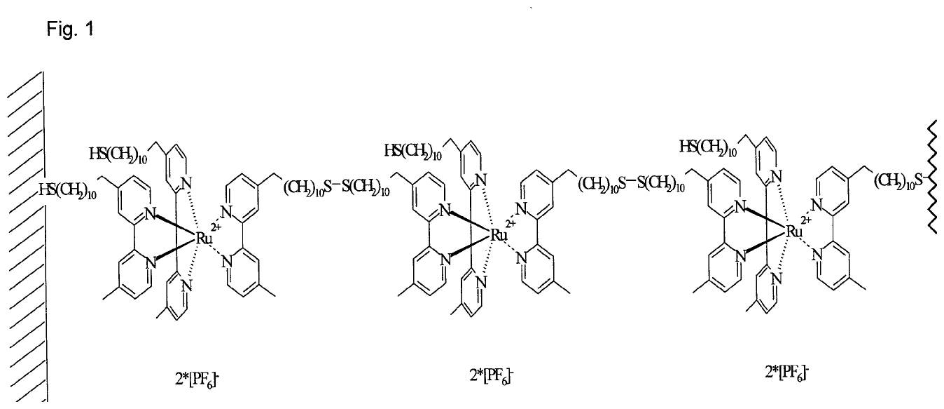

FIG. 2 shows a schematic representation of poly[N,N-bis-(1,13-dimercaptotridec-7-yl)-perylene-3,4:9,10-tetrabarboxylic acid bismide] attached to a gold surface.

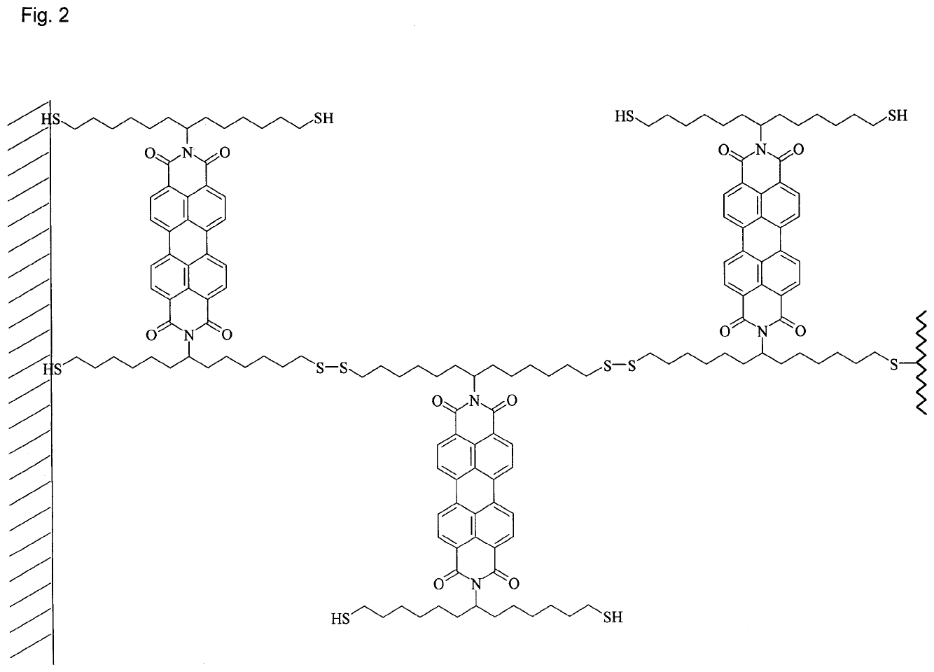

### DETAILED DESCRIPTION

The present invention relates to a photosensitizer comprising an oligomeric or polymeric chromphore that includes at least 3 monomeric chromophore units and absorbs light at a wavelength at or greater than 420 nm and carries at least two substituents comprising alkylene, alkenylene and/or alkynylene chains having a chain length of at least 3 carbon atoms, the substituents being terminated by thiol groups, wherein the oligonerization or poylmerization is effected by combining two thiol groups of two individual monomeric units to form a disulfide connection between two chromophores. A photocathode comprising such a photosensitizer is able to reduce protons and compounds that can be reduced with hydrogen in good yields.

The oligomeric or polymeric chromophore comprises at least 3, in particular at least 4 monomeric units, preferably at least 6 monomeric units, more preferable at least 8 monomeric units and even more preferably a least 10 monomeric units.

The monomeric units may be identical or different.

Methods for forming disulfide bonds from two thiol groups are well known in the state of the art, see e.g. Michael B. Smith and Jerry March: “MARCH'S ADVANCED ORGANIC CHEMISTRY”, 6^{th} Edition, 2007, John Wiley & Sons, Inc., Hoboken, N.J., page 1785.

The photosensitizer comprising an oligomeric or polymeric chromphore that includes at least 3 monomeric chromophore units and absorbs light at a wavelength at or greater than 420 nm may in addition comprise a crosslinking agent that may or may not include chromophoric groups, the crosslinking agent being able to react with thiol groups on the chromophore not being involved in forming a disulfide bond. Reactive groups included in the crosslinking agent that can react with thiol groups (there must be at least two such groups be present in the crosslinking agent) are also well-known in the state of the art, see e.g. Michael B. Smith and Jerry March: “MARCH'S ADVANCED ORGANIC CHEMISTRY”, 6^{th} Edition, 2007, John Wiley & Sons, Inc., Hoboken, N.J., Subject Index, keyword “thiols”.

The examples show suitable monomeric chromophores and crosslinking agents useful in the present invention as well as methods of polymerizing them.

The photocathode including the photosensitizer of the present invention comprises a carrier or substrate with an electronically conductive surface. Suitable substrates are discussed in WO 2009/056348 A1, page 13, line 21, to page 14, line 1. The conductive surface of the carrier or substrate may e.g. be a metal surface, preferably a noble metal surface, such as gold surface, or an electronically conductive metal oxide surface, such as an ITO surface. The photosensitizer must be attached to the conductive surface in a fashion that allows electron transport from the conductive surface to the chromophore. A detailed discussion of this can be found in WO 2009/056348 A1, page 12, lines 13-41, and in the literature mentioned therein (Elena Galoppini, “Linkers for anchoring sensitizers to semiconductor nanoparticles”, Coordination Chemistry Review, 2004, Vol. 248, pages 1283-1297). With the present sensitizers having thiol terminating groups on the substituents comprising alkylene, alkenylene and/or alkynylene chains, the most convenient way of providing an electronically conducting linker between the chromophore and an electronically conductive surface is to provide a carrier with a gold surface to which the thiol groups can directly be attached.

On the surface of the photosensitzer opposite to the surface attached to the carrier, there is a catalyst directly attached to the thiols groups or, as the case may be, deprotonated thiol groups (sulfide groups) or disulfide groups, or the catalyst is indirectly connected to the thiol or sulfide or disulfide groups in an electronically conductive way, the catalyst being able to reduce protons or an organic compound that can be reduced with hydrogen, such as a water-soluble carboxylic acid or a water-soluble aldehyde (in other words, a so-called “hydrogenation catalyst”). The hydrogenation catalyst may be an organometallic complex with the thiol or sulfide or disulfide group of the oligomeric or polymeric sensitizer as one of the substituents (e.g. a rhodium complex), or it may be a translucent or transparent layer of solid hydrogenation catalyst (e.g. platinum or ZnO), optionally carried as the top layer or partial top layer, which is exposed to the aqueous medium containing protons in the form of H+ or hydronium ions or an organic compound that can be reduced with hydrogen, such as a water-soluble carboxylic acid or a water-soluble aldehyde, of one or more translucent or transparent layer(s) of one or more electronically conductive material(s), such as a metal or an electronically conductive metal oxide, said layer or layers being attached to the thiol or sulfide groups of the oligomeric or polymeric sensitizer or an electronically conductive linker group between the thiol, sulfide or disulfide groups and an anchoring group in a electronically conductive fashion (see the discussion above with regard to the electronically conductive surface material of the carrier and the attachment of the photosensitizer to the surface of the carrier).

A very preferred electronically conductive metal layer attached to the thiol, sulfide or disulfide groups of the sensitizer at the surface of the oligomer (polymer opposite to the surface thereof attached to the carrier in an electronically conductive fashion is a translucent or transparent gold layer deposited from a gold gas phase onto the terminating thiol groups or sulfide or disulfide groups of the photosensitizer.

Solid catalysts for reducing protons or an organic compound that can be reduced with hydrogen (generally known as hydrogenation catalysts) are well-known in the state of the art, see e.g. Michael B. Smith and Jerry March: “MARCH'S ADVANCED ORGANIC CHEMISTRY”, 6^{th} Edition, 2007, John Wiley & Sons, Inc., Hoboken, N.J., page 1054, “heterogenous catalysts”. A preferred heterogenous hydrogenation catalyst for the present photocathode is a one-atomic partial layer of platinum deposited from a gas phase thereof onto the translucent or transparent gold layer.

In order to avoid short circuits between the electronically conductive surface layer of the substrate and an electronically conductive translucent or transparent layer on the opposite side of the photosensitizer, the photosensitizer has to be completely surrounded by one or more dielectric coating layers. This dielectric coating that surrounds the oligomeric or polymeric photosensitizer must be chemically inert and a strong dielectric material. Such materials are well-known in the state of the art, see. e.g. “Dielectric materials for Electric Engineering”, Juan Martinez-Vega (Ed.), 2010, John Wiley & Sons, Inc., Hoboken, N.J., Suitable materials on a gold surface are e.g., Si₃N₄ (that has the advantage of being able to directly adhere to gold), SiC, e.g. as a top layer on SiO₂ or silicone materials, a dense non-porous quartz layer and so on (for material properties and methods of deposition see e.g. https://www.coursehero.com/file/18376010/2013-CCD-Material-Charts/ and http://www.aimcal.org/uploads/4/6/6/9/46695933/george.pdf). In the examples the formation of a multi-layer dielectric structure with two different components is shown, since this type of dielectric coating structure was the most convenient one in the laboratory scale.

In a device for reducing protons or a chemical compound that can be reduced by hydrogen in an aqueous medium, i.e. a photoelectrochemical cell or half-cell (if only the inventive photocathode is used together with a reducible chemical substance in an aqueous medium), the inventive photocathode must be connected with an electron source. Suitable electron sources are well-known in the art. A suitable electron source may e.g. be a conventional anode as used in batteries, a photovoltaic cell, a photoanode as e.g. disclosed in WO 2009/056348 A1 (designated there as first photoactive material), or anodes such as disclosed in US 2010/0133110 A1. The process of reducing protons or a chemical compound in oxidized form in an aqueous medium is initiated by electronic excitation of one or more chromophores next to the reducing catalyst by means of light (preferably sunlight) and the transfer of one or two electrons to one or to H+ to form H or H₂ or another reduced species that can be reduced by hydrogen. This leaves (a) positive hole(s) in the chromphore(s) of the inventive oligomer or polymer, which is then neutralized by the electrons from the electron source, and the described process can then be repeated. For an efficient functioning of the inventive cathode, the aqueous medium is preferably at a temperature above room temperature (23° C.), e.g at or above 45° C., more preferably at or above 50° C. and even more preferably at a temperature at or above 55° C., such as e.g. 60° C., but preferably below 90° C., more preferably below 80° C. and even more preferably below 70° C. Reduced compounds can be separated from the aqueous phase by suitable well-known means, if desired.

If the photoelectrochemical cell is used for photochemical splitting of water into oxygen and hydrogen, the anode is a photoanode, as e.g. described in WO 2009/056348 A1 (“first photoactive material”), and is also immersed in the aqueous medium, as also described in detail in WO 2009/056348 A1. Oxygen and hydrogen are formed at different sites and can be collected separately. If necessary, the photoanode and the photocathode can be separated by a proton-permeable membrane, such as a Nafion® membrane.

### EXAMPLES

### Example 1: Application of (a) Dielectric Insulating Layer(s) onto Gold-Coated Glass Sheets Serving as the Carrier of the Photocathode

Gold-coated galls sheets are acquired from the company ACM, Rue de la Gare, 78640 Villiers Sinat Frederic, France. They measured 50×25×1 mm, The sheets consist of Duran Glass having on one side a 0.4 μm Au 111 top layer, with an adhesion layer between the glass and the gold of either Ni/Cr (80/20) or Ti(on glass)/Pt(on top of the Ti).

An insulating dielectric layer is applied onto the gold layer in such a way that at each of the two 25 mm edges a strip of having a breadth of about 3 mm was not covered by the dielectric layer. Furthermore, a rectangle in the middle of the gold plate have a size of about 23×10 mm was not covered by the dielectric layer as well in such a way that the rectangle is completely surrounded by the dielectric layer in a symmetrical way.

### Example 1.1

The dielectric layer may consist of on acrylic lacquer layer. However, this layer is not very stable under the irradiation conditions of the cathode. Therefore, it is better replaced by an insulating dielectric multi-layer with at least two different components, as shown in Example 1.2.

### Example 1.2

A thin, bubble free layer of a silane adhering well to gold (Nanoflex TTN 500, available from Nano-Care Deutschland AG, comprising dibutylethers and 3-aminiopropytriethoxysilane) is applied onto the surface to be covered with a micro-fibre cloth and dried for 30 min at 250° C. On top of this, a thin SiOₓ-layer is applied by means of flame pyrolysis according to the SurASil® Verfahren (procedure) of the Company SurA Chemicals, GmbH, Am Pösener Weg 2, D-07751 Bucha bei Jena, Germany, with the aid of a SurAChem® Vorbehandlungsgerät VG 03 (pretreatment device) and a SurASil 600 cartridge in accordance with the instructions accompanying the Sur SurAChem® Vorbehandlungsgerät VG 03. Finally, a silica layer was applied on top of the SiOₓ layer by means of a sol-gel procedure. This was done in accordance with the disclosure of DE 109 09 551 C1, column 6, lines 50-54. Tetraethoxysilan (TEOS), Ethanol, H₂O and HNO₃ were mixed in a molar ration of 1:1.26:1.8:0.01 and vigorously agitated for 5 hours at room temperature. Big drops of the sol mixture were deposited on top of the SiOₓ layer prepared above and evenly distributed with a silicone spreading tool. The sol was then dried at 150° C. for 2 hours. This provides a solvent resistant stable dielectric two-component multilayer.

Some of the plates treated thus still show small instable areas at the edges adjacent to the neighbouring gold surface. Therefore, another dielectric layer is deposited on top of these plates, namely a Si₃N₄ layer produced by means of PECVD with SiH₄ and NH₃ (professional deposition by the company NTTF Coating GmbH, Markweg 30, 53618 Rheinbreitbach, Germany).

It should be mentioned here that Si₃N₄ alone can serve as the dielectric layer suited for the present purpose, if the gold surface is thoroughly pre-treated, since then the adhesion between gold and Si₃N₄ is sufficient.

### Example 2: Preparation of Tris[4-(11-mercaptoundecyl)-4′-methyl-2,2′-bipyridine]ruthenium(II)-bis-(hexafluorophosphate

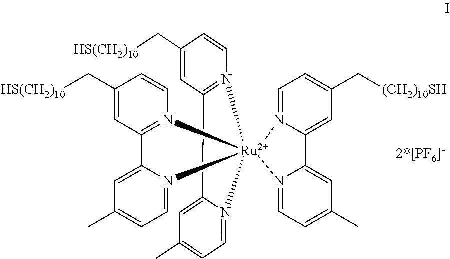

The title compound was prepared as described in WO 2009/056348 A1, Example 4.

### Example 3: Preparation of N,N-Di(1,13-dimercaptotridecan-7-yl)-perylen-3,4:9,10-dicarboxylic Acid Bisimide

### Example 3.1: Preparation of 7-Triphenylmethylmercaptoheptanenitril

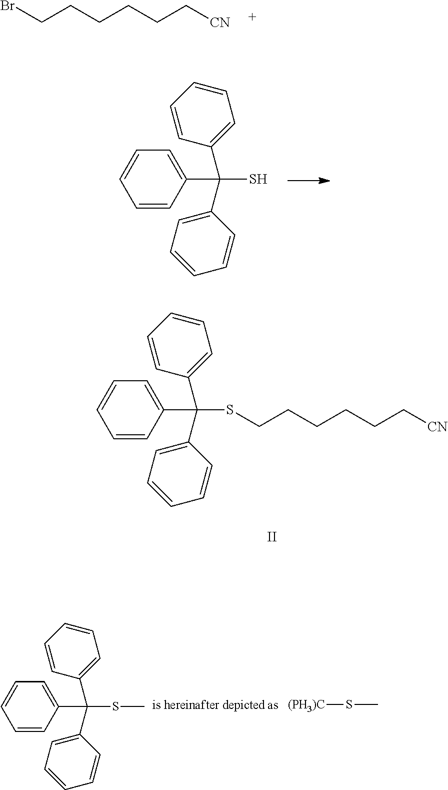

7.41 g triphenylmethanethiol (Chempur) and 10 ml of an aqueous 3M NaOH solution are stirred for 10 min at room temperature (RT), then 60 ml of ethanol are added. The solution is then stirred again for another 10 min, and 5.1 g (26.8 mmol) 7-bromo-heptanonitrile (ABCR GmbH) are added dropwise into the solution. After stirring for 7 days at RT, the reaction is quenched by the addition of 40 ml of saturated aqueous ammonium chloride solution. The organic phase is separated, and the aqueous layer is extracted with dichloromethane (3×40 ml). The combined organic phase is dried over MgSO₄. The solvent is removed by using a rotary evaporator. After drying under vacuum (9 mbar pressure, rt), 10.1 g (26.2 mmol; 98% yield) of the title product in the form of white solid are obtained. This is then purified by silica gel column chromatography (eluant: at first toluene for impurities, then dichloromethane (DCM): methanol (90:10) for the main fraction). 9.0 g, (90%) product of pure title compound are obtained as a white solid.

Melting Point: 102° C.

¹H-NMR (CDCl₃), δ: 7.4-7.35 (m, 6H), 7.30-7.20 (m, 9H), 2.3 (t, 2H, CH₂CN), 2.1 (t, 2H, tritylS-CH₂), 1.55 (t, 4H); 1.3 (m, 4H).

(Analogue to: Hara, K. et al. 2008, Angewandte Chemie; 120, 30, 5709-5712)

### Example 3.2: Preparation of 1-Bromo-6-(triphenymethyl)mercaptohexane

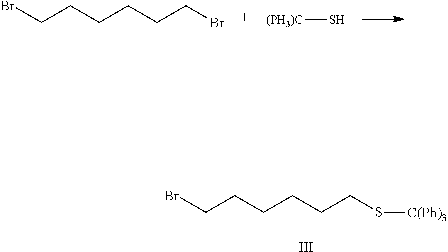

35.5 ml (54.6 g, 223.6 mmol) of 1,6-dibromohexane (ABCR GmbH) and 16.0 g (56.2 mmol; only half of the stoichiometrically required amount) of triphenylmethanethiol (Sigma Aldrich) are combined in a round-bottom the flask, and 200 ml of tetrahhydrofurane (THF) are added. Then, 14.4 g of NaH suspension (60% in mineral oil) corresponding to 8.64 g (360 mmol) NaH are added to the solution at room temperature, which is then refluxed for 2 days. The suspension is cooled down to RT and allowed to stand for 1 hour. NaH was filtered from the suspension and washed with dry THF. The combined THF solution are concentrated using a rotary evaporator. Then, 150 ml of hexane are added and the solution is placed in the refrigerator overnight to precipitate the product. The crystals formed are washed with cold hexane and vacuum dried. The title product is still contaminated with 1,6-dibromohexane starting material, since the mass of the crystals obtained (26.5 g) would correspond to 60.3 mmol (123%) of the title product; it was, however, used in the next step without further purification.

¹H-NMR (CDCl₃), δ: 7.4-7.35 (m, 6H), 7.30-7.20 (m. 9H), 3.40 (t, J=6.9, 2H), 2.13 (t, J=7.2, 2H), 1.84 (qn, J=7.2, 2H), 1.39-1.18 (m, 6H).

(Analogue to: Hara, K. et al. 2008, Angewandte Chemie; 120, 30, 5709-5712)

### Example 3.3: Preparation of 6-(triphenymethyl)mercaptohexane-1 magnesium bromide and 1, 13-Bis-[(triphenylmethyl)mercapto]-tridecan-7-one

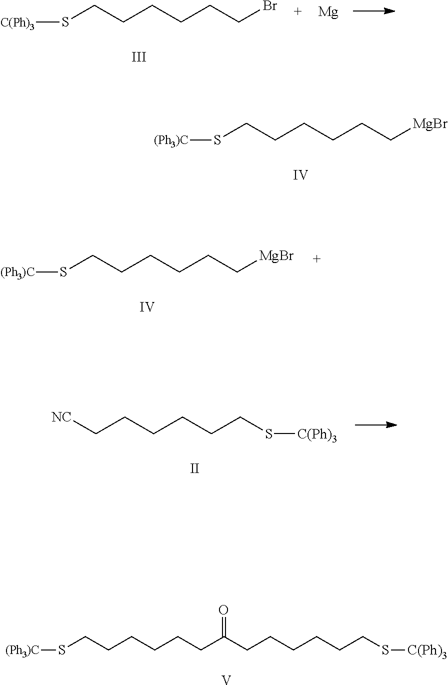

A 250 ml three-neck round-bottom flask, a pressure equalized dropping funnel, a glass stopper, a calcium chloride tube, a double surface reflux condenser and an egg shaped magnetic stirring bar are dried at 125° C. for 30 min before used. The flask is flushed thoroughly with N₂ and then filled with N₂. When still hot, 0.416 g; (17.1 mmol) of Mg powder is introduced into the flask. The flask is heated with a heat gun (temperature around 350° C. or more) under vacuum and agitation to dry the magnesium, and 1.0 ml of THF is added to the activated magnesium. Then a solution of 7.1 g (16.9 mmol) 1-bromo-6-(triphenylmethyl)mercaptohexane in 16 ml THF is slowly added dropwise with stirring for 30 min at room temperature and the at 65° C. for 2 h under reflux, until the formation of the Grignard reagent, is completed.

The solution is cooled to room temperature, and a dispersion of 5.75 g (14.9 mmol) of 7-(S-triphenylmethyl)mercaptoheptanonitrile, as prepared in Example 2.1, in 16 ml of anhydrous THF (pre-dissolved at 60° C. in THF) is added at room temperature with stirring under nitrogen. The color of the solution changes to pale green. The solution is then stirred for 3 h under reflux at 65° C. After the completion of the reaction, 30 ml of saturated ammonium chloride is cautiously added to the solution and stirred for 10 min.

The solution of the crude ketone product is extracted 3 times with 30 ml of dichloromethane. The combined organic phases are washed once with 45 ml saturated sodium carbonate solution, then with 45 ml water, dried with magnesium sulfate and filtered. The solvent is removed on a rotary evaporator at 40° C. The crude yellow product is dried under vacuum (9 mbar at room temperature) yielding 11.8 g (15.8 mmol). This is then purified using silica gel column chromatography, first eluating with hexane for the impurities and then with hexane:ethylacetate (90:10). The yield of the final pure 1, 13-bis-(triphenylmethyl)mercaptotridecan-7-one product is 10.9 g (14.6 mmol; 98%).

¹H NMR (CDCl₃), δ: 7.4-7.35 (m, 6H), 7.30-7.20 (m. 9H), 2.0-2.4 (4 H, CH₂COCH₂), 2.1 (t, 4H, trt-SCH₂), 1.0-1.75 (m, 16H)

### Example 3.4: Preparation of 1, 13-Bis-[(triphenylmethyl)mercapto]-tridecan-7-oxime

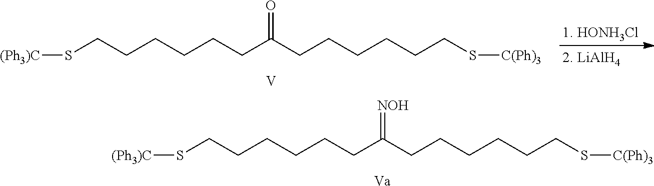

10.9 g (14.6 mmol) of 1, 13-bis-[(triphenylmethyl)mercapto]-tridecan-7-one are suspended in 25 ml of MeOH. 2.6 g (37.4 mmol) of hydroxylammonium chloride, NH₃(OH)Cl, are added and stirred at RT. Then, 78 ml of pyridine are slowly added with about 1 drop/s via a dropping funnel. The solution is vigorously for 25 h stirred at RT and then concentrated using a rotary evaporator for the removal of pyridine and methanol. The residue is distributed between water (ca. 90 ml) and ethyl acetate (EtOAc) (4 times ca. 90 ml each time). The combined organic layers are washed with 90 ml of 2M HCl, 90 ml of saturated aqueous Na₂CO₃ solution and 90 ml of water and dried over MgSO₄. The solvent is then evaporated using a rotary evaporator. The yield of the title product is 9.14 g (12.0 mmol, 82%).

¹H NMR (CDCl₃), δ: 8.75 (s, 1H, NOH), 7.4-7.35 (m, 6H), 7.30-7.20 (m, 9H), 2.2 (t, 4H), 2.1 (t, 4H, trt-SCH₂), 1.0-1.5 (m, 16H)

### Example 3.5: Preparation of 7-Amino-1,13-bis-[(triphenylmethyl)mercapto}-tridecane

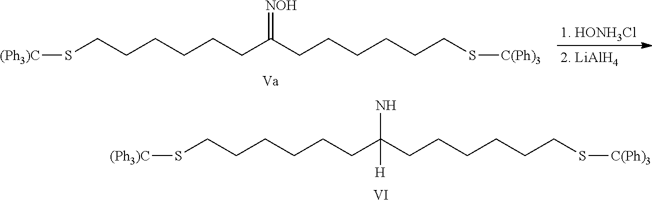

12.0 ml of a stock solution of AlH₄ in dry THF containing 29.2 mmol AlH₄ is added via a syringe and a septum to a dry 250 ml 3-neck round-bottom flask kept under a N₂ atmosphere. The solution is cooled in an ice bath, and 20 ml of dry THF are slowly added. 9.14 g (12.0 mmol) of 1, 13-bis-(triphenylmethyl)mercaptotridecan-7-oxime dissolved in 40 ml of THF are slowly added to the stirred solution of LiAlH₄ in the ice bath via the septum using a syringe. After completion of the addition, the solution is stirred under reflux at 70° C. for 4 h. The solution is then cooled to 0° C., and 40 ml of water are slowly added. This is followed by the addition of 20.0 ml of 6 M NaOH. The solution is stirred for about 30 min before filtration to remove solids. The crude product solution is then distributed between water and THF/ethyl acetate (1:1) and after separation extracted two more times with THF/ethyl acetate. The organic phase is then dried over MgSO₄ and evaporated on a rotary evaporator. After drying under high vacuum, the yield of the title product is 8.0 g (10.7 mmol, 89.2%).

¹H NMR (CDCl₃), δ: 7.4-7.35 (m, 6H), 7.30-7.20 (m. 9H), 2.3 (t, 4H), 2.1 (t, 4H, trt-SCH₂), 1.0-1.5 (m, 16H), 0.5 (br s, 2H, NH₂)

### Example 3.6: Preparation of N,N-Bis-[1,13-bis-[(triphenylmethyl)mercapto]-tridec-7-yl]-perylene-3,4:9,10-tetrabarboxylic acid bisimide

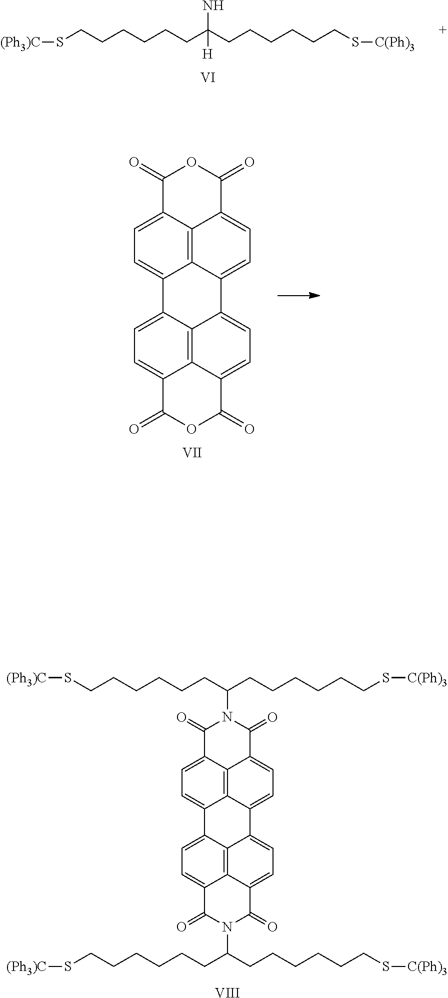

1.99 g (5.1 mmol) of perylene-3,4:9,10-tetrabarboxylic acid dianhydride (PTCDA) (Sigma Aldrich) and 185.7 mg (1.0 mmol) of Zn acetate are dissolved in 20 g of molten imidazole at about 100° C. Then 8.0 g (10.7 mmol) of 7-amino-1,13-bis-[(triphenylmethyl)mercapto]-tridecane are dissolved in 12 ml of toluene and slowly added to the vigorously stirred PTCDA mixture. After complete addition the solution is stirred at 130° C. for 3 h. Then, the toluene solvent and water are removed under vacuum at 80° C. After cooling to 60° C., 70 ml of methanol and 310 ml of 2M HCl are added. The solid residue which is the title product is collected by filtration, washed with about 150 ml each of 2M HCl and then methanol. The filter is washed with 40 ml of dichloromethane (DCM) in order to re-dissolve the crude product. DCM is removed from the filtrate using a rotary evaporator, and the residue is further dried under vacuum (9 mbar pressure, at 40° C.) to yield 8.2 g (4.4 mmol, 86.3%) of crude N,N-Bis-[1,13-bis-(triphenylmethyl)mercapto-tridec-7-yl]-perylene-3,4:9,10-tetrabarboxylic acid bismide. This is further purified by column chromatography using DCM as an eluant yielding 4.5 g of pure product (55%). A second fraction (1.95 g, 24%) still contained starting material.

¹H NMR (CDCl₃) δ 8.76 (br. s, 4H, arom.). 7.4-7.35 (m, 19H, arom.), 5.56 (t, 2H, N—CH), 2.65 (t, 8H, trt-SCH₂), 2.12 (8H), 1.57-0.85 (m, 32H)

### Example 3.7: Preparation of N,N-Bis(1,13-dimercaptotridec-7-yl)-perylene-3,4:9,10-tetrabarboxylic Acid Bismide

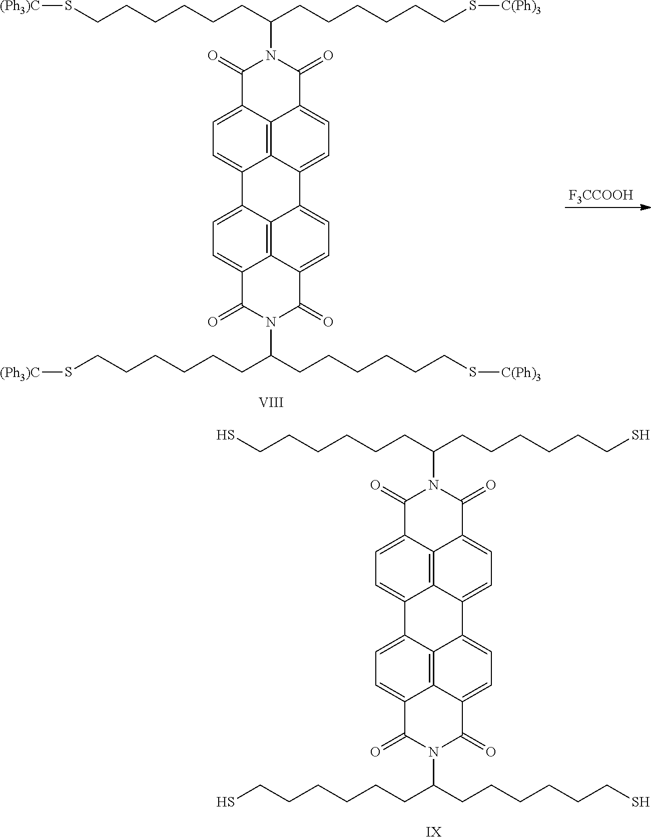

3.0 g, (1.62 mmol) of N,N-Bis-[1,13-bis-(triphenylmethyl)mercapto-tridec-7-yl]-perylene-3,4:9,10-tetrabarboxylic acid bismide are dissolved in 10 ml of dry DCM. Then, 1.3 ml (1.87 mg, 16.4 mmol) of trifluoroacetic acid (TFA) and 0.55 ml (400 mg; 2.52 mmol) of triisopropylsilane (TIPS) are added. The reaction mixture is stirred for 3 h. Then, the solvent and most TFA and TIPS were distilled off under reduced pressure. The deprotected red N, N′ Bis-(1,13-dimercaptotridec-7-yl) perylene 3,4:9,10-tetra carboxylic acid bismide was further dried in high vacuum (9 mbar, RT) yielding 1.42 g (99.6%) of the title product.

¹H NMR (CDCl₃), δ: 8.75 (br. s, 4H, arom.), 7.2-7.4 (br. s, 4H, arom.) 5.25 (2H, N—CH), 4.3 (4H, S—H), 2.5 (8H, methylene), 1.6-0.75 (m, 42H)

### Example 4: Polymerization of Tris[4-(11-mercaptoundecyl)-4′-methyl-2,2′-bipyridine]ruthenium(II)-bis-(hexafluorophosphate)

### Example 4.1: In situ polymerization of tris[4-(11-mercaptoundecyl)-4′-methyl-2,2′-bipyridine]ruthenium(II)-bis-(hexafluorophosphate) on Gold Surface

Tris[4-(11-mercaptoundecyl)-4′-methyl-2,2′-bipyridine]ruthenium(II)-bis-(hexafluorophosphate) was dissolved in CH₂Cl₂.

A 25×50 mm glass slides having a 0.4 m Au 111 coating on top of a 5-10 nm Co/Ni adhesion layer are pre-treated with a polyvinyl lacquer as described in Example 1 above.

These slides are put in an oven at about 120° C. Then a few drops of the tris[4-(11-mercaptoundecyl)-4′-methyl-2,2′-bipyridine]ruthenium(II)-bis-(hexafluorophosphate) solution in CH₂Cl₂ are dropped onto the free rectangular gold-covered area of about 10×23 mm in the centre of the slide, immediately followed by two drops SO₂Cl₂. Then the slide was put back in the oven for about 5-7 minutes, and this procedure was repeated for about 7-10 times. A dark red polymer formed on top of the untreated area in the centre of the slide.

### Example 4.2: Polymerization of Tris[4-(11-mercaptoundecyl)-4′-methyl-2,2′-bipyridine]ruthenium(II)-bis-(hexafluorophosphate)

20 mg (13.7 μmol) of Tris[4-(11-mercaptoundecyl)-4′-methyl-2,2′-bipyridine]ruthenium(II)-bis-(hexafluorophosphate) are dissolve in 20 ml of toluene:chloroform (50:50) solvent mixture in a 100 ml 3-neck flask. The solution is heated to 40° C. and then to 50° C. to dissolve the complex as much as possible. 0.4 ml SO₂C12 (0.69 g, 5.0 mmol) are gradually added in small portions while the solution is further heated to 60° C. under stirring. Two scrubbers are used for trapping HCl and SO₂ gas. When SO₂Cl₂ is added at or above 55° C., the polymerization is observed to start with strong gas evolution. After 35 minutes the polymerization reaction is stopped. The solvent is then removed under vacuum. The solid dark red polymer is four times washed with acetone to remove un-reacted monomers. The residue is not soluble in any other solvent except dimethyl formamide (DMF) at 60° C. Size exclusion chromatography shows the molecular weight to be ˜700, 000 Da.

### Example 4.3: Copolymerization of Tris[4-(11-mercaptoundecyl)-4′-methyl-2,2′-bipyridine]ruthenium(II)-bis-(hexafluorophosphate) and Pentaerythritol Tetraacrylate

79.0 mg (54.1 μmol) of tris[4-(11-mercaptoundecyl)-4′-methyl-2,2′-bipyridine]ruthenium(II)-bis-(hexafluorophosphate) is mixed with 21 mg, (54.1 μmol) pentaerythritol tetraacrylate (PETA) (Sigma Aldrich) in 30 m of toluene/chloroform (50:50 by volume). The mixture is heated under stirring to 60° C. Then, 0.4 ml SO₂Cl₂ (0.69 g, 5 mmol), is added in two portions (1 hour interval), and the reaction is allowed to continue for 24 h altogether. 10 ml of water are added, followed by methanol and filtration. The red solid copolymer was washed several times with acetone.

### Example 5: Polymerization of N,N-Bis-(1,13-dimercaptotridec-7-yl)-perylene-3,4:9,10-tetrabarboxylic Acid Bisimide

### Example 5.1: Polymerization of N,N-Bis-(1,13-dimercaptotridec-7-yl)-perylene-3,4:9,10-tetrabarboxylic Acid Bisimide

450 mg (0.541 mmol) of N,N-Bis-(1,13-dimercaptotridec-7-yl)-perylene-3,4:9,10-tetrabarboxylic acid bismide are dissolve in 5 ml dichloromethane (DCM) solvent in a 100 ml flask. 0.38 ml of TEA (2.74 mmol) is added. The mixture is vigorously stirred under air for 15 min, followed by dropwise addition (0.1 ml/5 min) of 1.5 ml of aqueous hydrogen peroxide (0.88 M, 1.32 mmol, 45 mg peroxide). The reaction is left stirring for 24 h which allows a gradual increase of size of the polymer until it precipitates. The excess TEA is decanted and the polymer is vacuum dried. Then, the polymer precipitate is washed with water, followed by methanol (2 ml). The dark orange polymer is then repeatedly rinsed with acetone on a filter, until the wash solution becomes colorless, and then dried under vacuum.

Size exclusion chromatography shows that the polymer has a molecular weight of around 10 kDa:

### Example 5.2: Copolymerization of N,N-Bis-(1,13-dimercaptotridec-7-yl)-perylene-3,4:9,10-tetrabarboxylic Acid Bisimide and Pentaerythritol Tetraacrylate

100.0 mg (113.6 μmol) of N,N-Bis-(1,13-dimercaptotridec-7-yl)-perylene-3,4:9,10-tetrabarboxylic acid bismide is mixed with 6.5 mg (18.4 μmol of Pentaerythritol tetraacrylate (PETA)) (Sigma Aldrich) in 10 ml THF. The mixture is stirred for 15 min at RT. Then, 1.0 ml (0.73 mg, 7.2 μmol of TEA is added at once to start the polymerization and allowed to stir for 3 h open to air and further 21 hours closed loosely with a stopper. Afterward, 10 ml of water are added, followed by methanol and filtration. The dark orange solid polymer is washed several times with acetone.

### Example 6: Deposition of Pre-Synthesized Poly{tris[4-(11-mercaptoundecyl)-4′-methyl-2,2′-bipyridine]ruthenium(II)-bis-(hexafluorophosphate)} on Gold Surface

In the following experiments gold coated glass sheets partly covered by a multi-component multi-layer dielectric coating as prepared in Example 1.2 above are used.

### Example 6.1: Deposition of Poly{tris[4-(11-mercaptoundecyl)-4′-methyl-2,2′-bipyridine]ruthenium(II)-bis-(hexafluorophosphate)} from Toluene/Chloroform Solution

A gold-coated glass sheet having an dielectric coating on part of its surface is placed in a dry 100 ml 3-neck flask and two times vacuum dried and purged with N₂.

A toluene/chloroform (50:50 by volume) mixture is gradually added to a solid DCM soluble deep red poly{tris[4-(11-mercaptoundecyl)-4′-methyl-2,2′-bipyridine]ruthenium(II)-bis-(hexafluorophosphate)} fraction (oligomeric and low molecular weight polymeric fraction) that had been extracted with acetone from bigger acetone-insoluble polymer under nitrogen and stirring until all polymer is dissolved and then added to the gold-coated glass sheet in the 3-neck flask under nitrogen until the glass sheet is covered completely. The solution is heated to 60° C. and stirred for 10 minutes, then left standing for 72 hours.

The plate is removed from the polymer solution and vacuum dried. Then, the plate is rinsed with three times with DCM and further vacuum dried. All gold surfaces of the sheet are completely covered with red polymer.

The polymer on the two gold surfaces in the form of bands at the two long ends of the plate was removed with Caro's acid, since for later experiments these surfaces have to be conducting.

The plate is stored under N2.

### Example 6.2: Deposition of Poly{tris[4-(11-mercaptoundecyl)-4′-methyl-2,2′-bipyridine]ruthenium(II)-bis-(hexafluorophosphate)} from DMF Solution

In this experiment a DMF soluble fraction of higher molecular weight poly{tris[4-(11-mercaptoundecyl)-4′-methyl-2,2′-bipyridine]ruthenium(II)-bis-(hexafluorophosphate)} from which lower molecular weight fractions have been removed by means of extraction with acetone is used.

Also another approach for applying the solution is chosen, since the removal of unwanted polymer on the two gold bands at both ends of the plate is tedious.

Thus, a highly concentrated and viscous solution of the above polymer in DMF is dropped on the rectangular gold surface in the centre of the plate with a syringe until the gold surface is covered completely. Some solution spreads onto the dielectric coating around that rectangular gold surface, but spreading to the gold bands at both ends of the plate could be avoided. The plate is then placed in the oven at 180° C. and monitored. As soon as the solvent has essentially evaporated, the plate is taken out of the oven and the procedure is repeated, until a complete, relatively thick coverage of the central gold surface is observed (usually 4-6 times). After cooling, the polymer deposited on the dielectric coating can easily be removed by means of a cotton stick soaked isopropanol.

### Example 6.3: Deposition of Poly{tris[4-(11-mercaptoundecyl)-4′-methyl-2,2′-bipyridine]ruthenium(II)-bis-(hexafluorophosphate)-co-pentaerythritol tetraacrylate} from DMF Solution

A high molecular weight fraction of the title polymer prepared in Example 4.3. is dissolved in DMF and deposited on the gold surface within 4 minutes, as described in Example 6.2 above.

### Example 7. Deposition of Pre-Synthesized Poly[N,N-bis-(1,13-dimercaptotridec-7-yl)-perylene-3,4:9,10-tetrabarboxylic Acid Bismide] on Gold Surface

In the following experiments gold coated glass sheets partly covered by a multi-component multi-layer dielectric coating as prepared in Example 1.2 above are used.

### Example 7.1: Deposition of Poly[N,N-bis-(1,13-dimercaptotridec-7-yl)-perylene-3,4:9,10-tetrabarboxylic acid bisimide] from Toluene/Chloroform mixture

A DCM soluble fraction of the title polymer is dissolved in a round-bottom flask in that solvent which afterwards is removed and replaced by a 50:40 toluene/chloroform/mixture under air to dissolve the polymer. The solution is added to a 3-neck round-bottom flask containing a gold-coated sheet so that the sheet is covered completely. The solution is heated to 50° C. under air. Then, the flask is put under a nitrogen atmosphere and heating continued for three days.

After removal of the sheet from the flask, rinsing with isopropanol and drying it can be discerned that the gold surfaces have complete coverage with a monolayer of the title polymer. Polymer on the gold bands at both long ends of the plate has to be removed again with Caro's acid.

This experiment is repeated, however with the addition of 10 drops of diisopropylethylamine (DIPEA, Hünig base) as soon as the solution has reached 50° C. There was, however, no change in the resulting polymer deposition.

### Example 7.2: Deposition of Poly[N,N-bis-(1,13-dimercaptotridec-7-yl)-perylene-3,4:9,10-tetrabarboxylic Acid Bisimide] from DMF

25 mg of the title polymer are dissolved in dry DMF under heating. 50 ml of dry DMF are added to the polymer in three batches (15 ml, 15 ml, and 20 ml) in intervals, until all polymer is dissolved. Thereafter, the reaction was put under a nitrogen blanket and stirred for 5 hours at 130° C., then for 4 days at 140° C.

All gold surfaces are completely covered with polymer, the coverage being thicker than the one obtained from the toluene/chloroform mixture in chapter 7.1. The polymer on the two gold bands at the two long ends of the plate is again removed with Caro's acid.

### Example 7.3: Deposition of Poly[N,N-bis-(1,13-dimercaptotridec-7-yl)-perylene-3,4:9,10-tetrabarboxylic Acid Bisimide] from DMF in the Oven

Again, the approach for applying the solution in an oven is also chosen, so as to avoid the removal of unwanted polymer on the two gold bands at both ends of the plate by means of Caro's acid.

The title polymer is pre-dissolved in a small amount of DCM and then mixed with one and a half of that amount with DMF. The DCM is then removed. The viscous solution is dropped via a syringe on the rectangular gold surface in the centre of the plate until the gold surface is covered completely. Some solution spreads onto the dielectric coating around that rectangular gold surface, but spreading to the gold bands at both ends of the plate could be avoided. The plate is then placed in the oven at 180° C. and monitored. As soon as the solvent has essentially evaporated, the plate is taken out of the oven and the procedure is repeated, until a complete, relatively thick coverage of the central gold surface is observed (usually 4-6 times). After cooling, the polymer deposited on the dielectric coating can easily be removed by means of a cotton stick soaked isopropanol.

### Example 7.4: Deposition of Poly[N,N-bis-(1,13-dimercaptotridec-7-yl)-perylene-3,4:9,10-tetrabarboxylic Acid Bisimide-Co-Pentaerythritol Tetraacrylate] from DMF in the Oven

A gold-coated glass sheet with a partial dielectric coating is placed into a 3-neck round-bottom flask. A solution of poly[N,N-Bis-(1,13-dimercaptotridec-7-yl)-perylene-3,4:9,10-tetrabarboxylic acid bisimide-co-pentaerythritol tetraacrylate], prepared in Example 5.2, in a mixed toluene(chloroform (50:50) solvent is added to the flask so as to cover the sheet completely. The mixture is stirred and heated to 60° C. under nitrogen. At 60° C., the stirring is stopped, and the deposition is allowed to continue for 4 days. After removal of the plate from the flask, drying in vacuum and thorough rinsing with isopropanol, a complete coverage of all gold surfaces with the copolymer becomes visible. The copolymer on the side-bands of the plate is again removed with Caro's acid.

### Example 8: Co-Deposition of Two Different Polymers

The deposition of poly[N,N-bis-(1,13-dimercaptotridec-7-yl)-perylene-3,4:9,10-tetrabarboxylic acid bisimide] from DMF as described in Example 7.2:was repeated. Then Poly[N,N-bis-(1,13-dimercaptotridec-7-yl)-perylene-3,4:9,10-tetrabarboxylic acid bisimide] is pre-dissolved in a small amount of DCM and then mixed with one and a half of that amount with DMF and the DCM is then removed, as described in Example 7.3 above. This solution was then dropped onto the deposition of poly[N,N-bis-(1,13-dimercaptotridec-7-yl)-perylene-3,4:9,10-tetrabarboxylic acid bisimide] in a similar way as described in Example 7.3 over about 4 minutes.

### Example 9

The plates of Examples 4.1, 6.1-6.3, 7.1.-7.4 and 8 are further treated in a high vacuum chamber so as to deposit a thin gold layer or coverage (ca. 5 nm) on top of the polymer on the rectangular gold surface in the centre of the plate and overlapping the inner part of the adjacent dielectric coating, and as to further deposit a 0.4-0.7 monolayer of platinum on the gold layer covering only 50 to 70% of the gold surface of platinum on top of the gold coverage.

### Example 10: Combination of the Plates of Examples 4.1, 6.1-6.3, 7.1.-7.4 and 8 with a TiO₂/RuS₂-Covered ITO Plate

This combination was produced as described as described in Example 7.1.a. of WO 2009/056348 A1.

### Example 11: Irradiation in D₂O

The combination of Example 10 was immersed into D₂O in a nitrogen atmosphere in an irradiation test tube and irradiated from both side with a 500 W tungsten lamp through a Duran® beaker filled with water at a temperature of 60-65° C., in which the irradiation test tube was immersed.

In all cases a strong peak at about 6 min retention time in a gas chromatograph (Shimadzu) set up for the detection of H₂/D₂ at a retention time of about 6 minutes appeared. The mass spectrum showed strong D and D₂ peaks. The acrylic lacquer used in Example 4.1 proved not be stable under the under the conditions of irradiation and decomposed completely with longer irradiation times.

The entire content of all patents, patent applications, literature articles, books and parts of books cited in this specification is herewith incorporated herein by reference.

1.-10. (canceled)

11. A photosensitizer, wherein the photosensitizer comprises an oligomeric or polymeric chromphore which absorbs, as an ensemble, light at wavelengths of 420 nm or longer and comprises (i) at least 3 identical or different monomeric chromophore units carrying at least two substituents and each comprising at least one alkylene, alkenylene and/or alkynylene chain having a chain length of at least 3 carbon atoms and being terminated by thiol groups, and (ii) disulfide bonds between the chromophores, prepared by combining two thiol groups of two individual monomeric units by oligomerization or poylmerization of the monomeric units to form the oligomeric or polymeric chromphore.

12. The photosensitizer of claim 11, wherein the photosensitizer further comprises at least one crosslinking agent that reacts with excess thiol groups not involved in forming the disulfide bonds.

13. The photosensitizer of claim 12, wherein the at least one crosslinking agent does not include a chromophore.

14. The photosensitizer of claim 11, wherein the photosensitizer consists of identical oligomerized or polymerized chromophore units.

15. The photosensitizer of claim 12, wherein the photosensitzer consists of identical oligomerized or polymerized chromophore units and the at least one crosslinking agent.

16. The photosensitizer of claim 13, wherein the photosensitzer consists of identical oligomerized or polymerized chromophore units and the at least one crosslinking agent.

17. The photosensitizer of claim 11, wherein the photosensitizer consists of different oligomerized or polymerized chromophore units.

18. The photosensitizer of claim 12, wherein the photosensitzer consists of different oligomerized or polymerized chromophore units and the at least one crosslinking agent.

19. The photosensitizer of claim 13, wherein the photosensitzer consists of the different oligomerized or polymerized chromophore units and the at least one crosslinking agent.

20. A photocathode, wherein the photocathode comprises the photosensitizer of claim 11.

21. A photocathode, wherein the photocathode comprises the photosensitizer of claim 12.

22. The photocathode of claim 20, wherein the photocathode further comprises (a) a carrier having an electronically conductive surface on a side connected to a layer comprising the photosensitizer, (b) a dielectric coating surrounding the photosensitizer between the electronically conductive surface of the carrier and an electronically conductive layer on top of a layer comprising the photosensitizer on a side opposite the side connected to the conductive carrier surface, and (c) a catalyst in contact with an aqueous medium for reducing protons in the aqueous medium and/or a chemical compound dissolved in the aqueous medium that can be reduced by hydrogen.

23. The photocathode of claim 21, wherein the photocathode further comprises (a) a carrier having an electronically conductive surface on a side connected to a layer comprising the photosensitizer, (b) a dielectric coating surrounding the photosensitizer between the electronically conductive surface of the carrier and an electronically conductive layer on top of a layer comprising the photosensitizer on a side opposite the side connected to the conductive carrier surface, and (c) a catalyst in contact with an aqueous medium for reducing protons in the aqueous medium and/or a chemical compound dissolved in the aqueous medium that can be reduced by hydrogen.

24. A device for reducing protons in the aqueous medium and/or a chemical compound dissolved in the aqueous medium that can be reduced by hydrogen, wherein the device comprises the photocathode of claim 20 and an electron source in electrically conductive connection with the photocathode.

25. A device for reducing protons in the aqueous medium and/or a chemical compound dissolved in the aqueous medium that can be reduced by hydrogen, wherein the device comprises the photocathode of claim 21 and an electron source in electrically conductive connection with the photocathode.

26. The device of claim 24, wherein the electron source is selected from a conventionally biased anode, a photovoltaic cell or a photoanode immersed into an aqueous medium.

27. The device of claim 25, wherein the electron source is selected from a conventionally biased anode, a photovoltaic cell or a photoanode immersed into an aqueous medium.

28. A method of reducing in an aqueous medium protons or a chemical compound that can be reduced by hydrogen, wherein the method comprises immersing the photocathode of claim 20 in an aqueous medium containing protons or protons and the chemical compound that can be reduced by hydrogen at a temperature above room temperature, the photocathode being connected to an electron source in an electronically conductive manner and being irradiated with light in a visible region comprising wavelengths of 420 nm or longer, and wherein the method further comprises collecting hydrogen produced at the photocathode or collecting the chemical compound reduced at the photocathode within the aqueous medium or separating the chemical compound reduced at the photocathode from the aqueous medium.

29. The method of claim 28, wherein the electron source is a photoanode which is also immersed in the aqueous medium or a different aqueous medium.

30. A method of reducing in an aqueous medium protons or a chemical compound that can be reduced by hydrogen, wherein the method comprises immersing the photocathode of claim 21 in an aqueous medium containing protons or protons and the chemical compound that can be reduced by hydrogen at a temperature above room temperature, the photocathode being connected to an electron source in an electronically conductive manner and being irradiated with light in a visible region comprising wavelengths of 420 nm or longer, and wherein the method further comprises collecting hydrogen produced at the photocathode or collecting the chemical compound reduced at the photocathode within the aqueous medium or separating the chemical compound reduced at the photocathode from the aqueous medium.
